(19) United States
(12) Patent Application Publication
(10) Pub. No.: US 2026/0159908 A1
(43) Pub. Date: Jun. 11, 2026

(54) ADDITIVE COMPOSITION AND METHOD FOR CHEMICALLY ADJUSTING MOLTEN METAL

(71) Applicant: Hatch Ltd., Mississauga (CA)

(72) Inventors: Sa GE, Mississauga (CA); Ian Archibald CAMERON, Mississauga (CA); Terrence Leonard George KOEHLER, Mississauga (CA)

(21) Appl. No.: 19/123,905

(22) PCT Filed: Oct. 25, 2023
(86) PCT No.: PCT/CA2023/051418

§ 371 Date: Apr. 24, 2025

Related U.S. Application Data
(60) Provisional application No. 63/419,273, filed on Oct. 25, 2022.

(51) Int. Cl. C21B 3/02; C21B 13/00; C21B 13/12

(52) U.S. Cl. CPC C21B 3/02; C21B 13/008; C21B 13/12

(57) ABSTRACT

An additive composition for providing a chemical additive to liquid metal in a furnace, and a method for adjusting the chemical composition of molten metal in a furnace. The additive composition comprises an additive component and a ballast component. The ballast component is a high-density component, the high-density component for helping the additive composition to sink through the slag layer to contact the molten metal using the force of gravity.

### FIELD

The present invention relates to metallurgy and more specifically to creating molten metal with a target chemical composition within a furnace.

### BACKGROUND

When smelting ores or other metal-containing elements (such as direct reduction iron) in a furnace, the material separates into molten metal and slag. Slag typically comprises a mixture of metal and non-metal oxides and in some cases may contain metal sulfides and elemental metals. Slag typically comprises a density of 1.5-2.5 g/cm³ and floats as a layer at the surface/on top of the molten hot metal layer since the hot liquid metal has a higher density than that of the slag. In some cases, the slag forms a stagnant or stable layer above the metal, and in other cases of more violent or stirred vessels, the slag may be foamy or turbulent.

The molten liquid metal composition is typically determined by the composition of the charging agent. For example, a hot liquid metal composition may be determined by the ore or direct reduced iron (DRI) charged into the furnace.

Frequently, however, the chemical composition of the molten metal needs to be further adjusted to achieve the desired metal composition. Adjustment of the composition of the metal may be possible once the molten metal has been removed from the furnace. Sometimes, however, it is more efficient, or it is only possible, to change the composition of the molten metal during the melting/smelting process while the metal is in the furnace.

Smelting direct reduced iron in an electric furnace to produce hot metal is one example application where it is important to deliver metal chemical additives-and especially carbon-to the molten hot metal layer during the smelting process. Hot metal in the present disclosure refers to molten pig iron which may also contain other elements such as carbon, silicon, etc. Blast furnaces have historically been used for ironmaking. The blast furnace produces molten pig iron (hot metal) from iron ore. The pig iron is then processed in a basic oxygen furnace (BOF) to produce steel. Blast furnaces may be fueled by coke (a derivative of coal) thereby resulting in a pig iron saturated with carbon (typically 4.5% by weight) and an overall furnace flowsheet that produces significant CO2 emissions. With the trend towards decarbonizing metal production flow sheets for environmental reasons, there is a growing interest in ironmaking using electric furnaces and especially electric smelting furnaces capable of processing DRI. However, such DRI electric smelting furnaces product hot metal without sufficient carbon content because of the absence of the blast furnace fueled by coke.

The chemical additives for adjusting the molten metal composition often needs to be added via the top of the furnace or similar vessel instead of the side or bottom because the bottom and sides of the vessel holding the molten metal must be strong and impervious to the intense heat and weight of the molten metal. However, delivering chemical additives to the molten metal layer via feeding the additives from the top is challenging due to the slag layer above the molten metal layer. That slag layer effectively acts like a barrier by inhibiting the additives from reaching the metal layer. The additives may have a same or lower density than the slag such that the additives reside atop or within the slag layer. The slag layer may also have surface tension which causes the additives to stay float atop the slag layer at the freeboard.

In some prior art methods, metal additives are introduced to the hot metal by injection or by hollow electrode addition. Injection methods comprising blowing the additive in a carrier gas exist, but they have been found to be unsuitable in certain application such as electric furnace environments requiring stable bath condition, or submerged arc operations. For example, injection methods are not suitable when charge banks exist inside the furnace and the injection causes stirring or foaming of the slag, such that a stable slag layer cannot be formed. Hollow electrode addition comprises adding additives through a hollow space in an electrode that penetrates into the slag but is unsuitable in some applications, such as processes with high gas evolution which may result in the gas escaping from the hollow of the electrode.

A way to provide chemical additives to a molten metal in a furnace is desired.

### BRIEF DESCRIPTION OF THE FIGURES

FIG. 1 is a block diagram illustrating a method for producing an additive composition according to embodiments of the present disclosure.

FIG. 2 is a block diagram illustrating a method for adjusting a composition of molten metal beneath a slag layer.

FIG. 3 shows a cross section of a portion of a furnace comprising an additive composition at a slag-metal interface.

### DETAILED DESCRIPTION

The present invention is for an additive composition for adjusting the chemical composition of hot liquid metal, and a method for adjusting the chemical composition of hot liquid metal. Adjusting the chemical composition of the hot liquid metal may be difficult due to a layer of slag floating on the surface of the hot liquid metal. The slag layer may be thick and stable, have a high surface tension, or of a density greater than the additive to adjust the chemical composition of the liquid metal. The additive for adjusting the chemical composition of hot liquid metal may be of a density lower than the density of slag, or in a form that is inhibited from sinking into the slag, or incapable of breaking the surface tension of the slag, such as fines, powders or loose particles. Charging the metal additive into the furnace from the top of the furnace may therefore result in the additives coming to rest and remaining in the freeboard, on the surface of the slag, or entirely within the molten slag layer. In such scenarios the additives may never reach the molten metal, potentially be consumed, such as by burning up at the freeboard for example, or melting, reacting, dissolving or otherwise being consumed in the slag. An additive composition in accordance with this invention may help better control the chemistry of the hot liquid metal through overcoming the problem of slag or a similar barrier above the molten metal inhibiting adding materials for adjusting the chemical composition of the metal.

The additive composition of the present invention comprises a ballast component and an additive component. The ballast component is a high density component with a density greater than the slag. The ballast may have a density similar to or greater than the molten metal. The combination of the ballast component and the additive component provide an additive composition that has an overall density greater than the density of slag. This allows the additive composition to sink through the slag layer to reach the molten metal layer. The additive composition is formed so as to overcome any surface tension of the slag layer, and to sink within the slag layer to come into contact with the hot liquid metal layer. Only some of the additive composition must come into contact with some of the metal layer. The additive composition may be formed so as to sink at least to the interface between the slag and the hot liquid metal.

Most molten metal and slag furnace applications comprise a slag layer with a first density, and a molten metal layer with a second density. The first density is less than the second density. Further, the densities of each of the slag layer and the molten metal layer are fairly uniform across the layer, such that the molten metal layer is fairly distinct from the slag layer so there is a distinct boundary or interface between the two layers. Ironmaking electric furnaces which melt DRI form distinct molten metal and slag boundaries between the two layers.

In an embodiment of the invention the additive composition need only have a density greater than the slag. An additive composition with a density greater than the slag will by its nature come to rest at least at the interface between the slag layer and the molten metal layer, even if the additive composition density is less than that of the metal layer. In other words, the additive composition may comprise a density somewhere in-between the density of the slag and the density of the molten metal so as to result in the additive composition coming to rest at the metal/slag interface. So long as the additive composition is at the interface between the two layers and the interface is distinct, this will help ensure at least some of the additive composition is in contact with the molten metal. Slag cleaning furnaces are an example of an application which may not have a distinct boundary between the slag layer and the molten metal layer, and which typically comprise an intermediary layer of slag metal mixture. That intermediary layer may comprise a non-homogeneous mixture of slag and molten metal and is effectively considered a slag phase chemically. As further explained below, slag phases (including intermediary phases) may be highly reactive with reductants, such as in the case of slag cleaning furnaces for copper.

Once the additive composition comes into at least partial contact with the metal layer, at least some of the metal additive will be received by, and dissolved into, the metal layer. This is the case irrespective of whether the additive composition is also in contact with the slag. Although the slag layer may have a higher temperature than the molten metal layer, molten metal has a higher rate of heat transfer than slag. This may result in the portion of the additive composition, which is in contact with the molten metal, melting faster than the portion of the additive composition which is in contact with the slag. The portion of the additive composition that is melted by the molten metal has a higher likelihood of providing its additive component to the molten metal for dissolution therein. This is in part because such additive composition would be exposed to the molten metal first which provides an opportunity for the reaction and interaction between the molten metal and the additive component to occur. If the rate of heat transfer to the additive component from the molten metal is sufficiently higher than that from the slag, in an embodiment only a nominal amount of the additive component may be lost to the slag with the majority becoming dissolved within the molten metal layer. In an embodiment, at least 30% of the additive component of the additive composition is dissolved within the molten metal.

The additive composition of this invention may be used with hot liquid metal (including any number of molten metals) and slag layers residing or produced in any number of vessels. For example, vessels as contemplated herein may be found in the fields of ferrous and non-ferrous metallurgy or pyro-metallurgy, ironmaking, or steelmaking, syngas production using plasma gasifiers, or may comprise a part of smelting furnaces, other electric furnaces (such as electric arc furnaces (EAF) and submerged arc furnaces (SAF)), induction furnaces, ladle furnace or ladle metallurgy furnace, or other metallurgical furnace equipment.

Metal additives that rest on top of the slag layer may burn up or become less effective or available due to reactions in the furnace freeboard atmosphere under the intense heat. This negatively affects the additives'ability to change the chemistry of the molten metal. Metal additives that come to reside within the slag layer may in certain applications, however, have unwanted chemical reactions with the slag that can materially negatively affect the molten metal itself. For example, although carbon is a chemical additive for hot metal electric furnaces which use DRI, carbon can also act as a reductant when in the presence of oxides. Slag always comprises one or more oxides. The slag in hot metal (iron) electric furnaces comprises silicon and manganese oxides. If a metal additive comprising carbon comes to reside within the slag layer of such an electric hot metal furnace, the carbon will reduce the silica to form silicon in the metal layer. Silicon reverts to the metal and is undesirable as it is an impurity and it lowers the yield of hot metal coming out of the furnace. Accordingly, in accordance with the invention, it is important for the additives for the metal to come to reside within the metal layer completely or at least partially to help inhibit the additives from interacting with the slag layer. Furthermore, it is preferable for the additives to pass through the slag layer and come into contact with the metal layer as quickly as possible. As the additive composition is passing through the slag layer it will begin to melt due to the heat of the slag. If the additive composition melts too much while in the slag layer, some of the additive component may also be melted or freed allowing the additive to potentially interact with the slag which is undesirable.

In an aspect, the additive composition comprises an additive component and a ballast component. The ballast component comprises a density that is greater than the density of slag thereby causing the additive composition to sink within the slag and come to reside at a location within the molten bath of the furnace such that it is in contact with at least some of the molten metal. The ballast component effectively sinks the metal additive component through the slag material and deposit the additive component in contact with the molten metal/matte. The combination of the ballast component and the additive component, with none or any one or more other components such as binder(s), may position the additive component within the optimal location relative to the metal layer.

In accordance with an embodiment of the invention, the method for producing an additive composition for adjusting the chemistry of hot liquid metal comprises selecting an additive component and the amount thereof, and a ballast component and the amount thereof, and chemically and/or physically binding the additive component and the ballast component together to create one or more units of the additive composition that are capable of both achieving the select chemical adjustment in the hot liquid metal, and also achieving the required overall density for each unit of the additive composition such that each unit will descend through the slag layer under only the force of gravity so as to at least partially contact the metal layer. The additive composition may comprise a plurality of units, each unit comprising the required density and amount of additive component, such that adding all of the plurality of units achieves the select chemical adjustment desired for the hot liquid metal.

The additive composition may be produced in any suitable form and number of units for charging into the vessel. For example, the additive composition may be produced in the form of a conglomerate, agglomerate, pellets, briquettes, micro-pellets, sintered particles, or bonded particles (all of the foregoing being a type of unit). Techniques for forming pellets, briquettes or bonded particles of DRI are generally known, and such techniques may be applied in combination with the present disclosure to create the additive composition in such forms. For example, different briquetting techniques exist which may be used to form the additive composition in the form of briquettes. Forming the additive composition may comprise adhering particles of the additive component and particles of the ballast component to one-another. These different briquetting processes may be used to yield a heavy briquette of an optimal size and quality for the process. For example, cold-bonding may be an efficient low-cost briquetting technique, while induration may produce stronger briquettes that can withstand higher temperature and more frequent or rough handling as may be experienced, for example, when in transport. Certain briquetting or post-processing techniques may also be used to promote chemical reactions within the additive composition that further promote desired dissolution or reactions. For example, DRI fine briquette induration may promote formation of cementite (Fe₃C), which may be beneficial for carburization of liquid iron. To form an additive composition unit, the additive component and the ballast component need only be bound together sufficiently so as to withstand the forces that it might experience from being provided into the vessel and descending through the slag layer.

The additive composition may be introduced into a vessel comprising slag and molten metal by any suitable means. Depending on the size and quality of the additive composition, the composition may be added to the vessel as a trim additive directly to the open slag area or may be added as a mixture with the other feed material. The addition of the additive composition may be achieved through any number of buckets, chutes, feed ports, pneumatic lances, or any other charging equipment appropriate for the application. The addition of the additive composition may be continuous, semi-continuous, or batched. In an example steel production process, a main feed of metal ores, DRI or other scrap metal may be charged into a vessel such as into an electric arc furnace. The charging may be through openings in the roof of the furnace. The additive composition as disclosed herein may be added, for example in a side stream, directly into the main feed, or directly into the vessel to help adjust the chemical composition of the molten metal. The main feed may comprise one or more feed materials.

The additive composition may be introduced periodically or continuously into the vessel. In an example, the additive composition may be provided to the furnace periodically and the chemical composition may be tested or monitored to determine whether the desired chemical composition is achieved or if more of the additive composition needs to be added. In another example, the molten metal chemical composition may be tested or monitored to determine whether a different ratio of additive in the additive composition is required to achieve a desired or target chemical composition in the molten metal.

The additive component of the additive composition may be any one or more of a combination of materials for adjusting the chemical composition of the molten liquid metal. In an example, the additive component may be any carbon, or iron containing additive. The additive component may be for example one or more of, coal, coke, anthracite, charcoal, biocarbon, biomass, cementite, or any number of various metal carbides, silicon, and sulphur. In a further example, the additive component may comprise one or more materials for adjusting the chemical composition of the molten liquid metal. In each case, the selected additive is based on the desired chemical composition adjustment of the molten liquid metal. Depending on the application, a material may or may not be an additive component as that term is used herein. Whether or not a material is an additive component depends on whether the material is dissolved and remains in the phase within which it is intended, and specifically in the molten metal in the subject application. For example, even though carbon can act as a reductant in the slag, carbon is still an additive component for hot metal because carbon has solubility in molten iron for carburization of the hot metal. When dissolved within the slag phase, the carbon is a reductant that reacts and gets entirely consumed (for example, carbon will react with iron oxide in the slag phase to product carbon monoxide gas which leaves the furnace as an off gas and does not remain within either the slag, including because carbon has no solubility in slag). Accordingly, where an additive could also be a reductant in the slag phase for a particular furnace, it is desirable to minimize the amount of the additive that may be exposed to/react with the slag. Furthermore, in some applications carbon will not dissolve with the liquid metal phase due to the metals themselves and therefor not be an metal additive in such applications. For example, carbon has no solubility with molten copper, accordingly carbon is not an additive component in a copper furnace.

In an example additive composition as disclosed herein, the additive component may comprise any one or more carbon additives such as anthracite, coke, charcoal, carbon fines, and other carbon containing components such as elemental carbon, carbon black and graphite, in order to increase the carbon content of the molten metal. Increased carbon may be desired for example to enable subsequent oxygen steelmaking to take place and may provide a variety of operational and product quality benefits. For example, in the oxygen steelmaking process, increased carbon forms carbon monoxide bubbles with the oxygen in the system, the bubbles in turn help refine the steel as they rise by picking up impurities within the steel. In another example, the presence of carbon in electric steelmaking processes (such as EAF), may help reduce electrical power requirements and increase throughput of the furnace. In another example, the additive component may comprise aluminum dross to achieve deoxidation of the molten metal. In this case, the aluminum will remove dissolved oxygen in the metal.

The ballast component of the additive composition as disclosed herein is used to increase the overall density of each unit of the composition. The overall density of each unit of the additive composition is greater than the density of the slag such that the additive composition unit, overall, is caused by the force of gravity alone to sink through the slag layer to contact the metal layer. In an example, the additive composition comprises a density sufficient to cause the composition to descend through the slag layer and to come to reside partially or entirely within the liquid metal layer. The density of the additive composition may be less than, equal to, or greater than the density of the liquid metal. In an example where the slag layer comprises a density of about 2.0-2.8 g/cm³, the ballast component of the additive composition may for example produce an overall additive composition unit with a density of about 2.5-4.0 g/cm³ in order for the additive composition to descend to the interface between the slag and molten metal layers.

In an example, any one or more of, metallic DRI such as DRI fines, finely shredded metal scraps, powdered or granulated iron, iron carbide, or ferroalloys may be used as the ballast component for the additive composition. The ballast component however does not need to be in the form of fines or powders but should be fine enough to allow for the component to bond and form the additive composition with the additive component. The ballast component melts and forms a part of the molten metal and/or slag and is therefore selected to be compatible with the molten metal and/or slag. A compatible ballast component should preferably have little to no effect on downstream operations and should preferably introduce little or no contaminants to the process. In another example, the ballast component comprises the same material as the molten liquid metal.

Different amounts and types of the ballast component may be used to select the overall density of the additive composition, such that it will have the necessary buoyancy and reaction behaviour to allow the additive component to react and dissolve in the hot metal. The amount of the ballast component to achieve the optimal buoyancy or density of the additive composition is determined by the proportion of the components in the additive composition as further described in this disclosure.

In some cases, a component may be used as an additive component as well as a ballast component, with or without additional high density or additive components. For example, Fe₃C may be used as a ballast component, or an additive component, or both the ballast and the additive components, depending on the chemical adjustment required, and/or the density of the slag and molten metal.

Optionally, the additive composition may further comprise one or more binders. The binder may be tailored for the desired shape and size and shelf-life of the additive composition. The binder is further selected based on the agglomeration technique (i.e. cold bonding, induration, etc.) used to form the additive composition and taking into account the environment where the binder will be used, for example, taking into account specific furnace operations such as the process tolerance of chemicals in the binding agent, feed location of the additive composition, and furnace freeboard temperature. The binder may comprise any one or more binding agents, including commercially available binding agents. In an example, the binder may comprise cement, molasses, bentonite, lime, and/or sodium silicate. Some commercial organic binding agents (e.g. BASF Alcotac™ series) that are based on high-density polymers (such as polyacrylamides) may be used. In some cases, the organic binding agents based on high density polymers may be preferred as a smaller quantity is typically needed for binding. Using less binder allows for proportionally more of the other components of the additive composition. In an example, the binder makes up a maximum of 15% of the additive composition by weight. In other examples, the binder makes up 0%, or 2%, or 4%, or 6%, or 8%, or 10%, or 12% by weight of the additive composition.

The additive composition may be formed by blending all of its components together or by blending at least two components and subsequently mixing in a third. For example, the additive composition may be formed by blending the ballast component and the additive component, and subsequently introducing a binder.

The additive composition may be produced on site at a metallurgical furnace plant or similar industrial facility or elsewhere depending on the process used for forming the composition. For example, cold bonding to form pellets or briquettes may limit the distance between where the composition is formed and where it is used because the cold bonding tends to break down in long transit. In some cases it may be preferable to produce the additive composition on site such as to allow for adjustment of the composition components quickly using raw material directly from the plant.

The proportion of the additive component, the ballast component, and optionally the binder to be used, to form the additive composition (in any number of units), is tailored based on the chemical composition of those components and the target density.

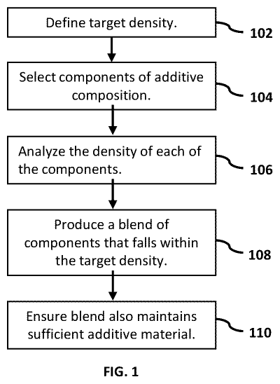

FIG. 1 is a block diagram illustrating a method of making the additive composition. The method comprises first defining a target density based on the molten metal and/or molten metal making process being used 102. The target density may be a range of densities. For example, the density difference between the slag and the molten metal may be determined and used to select a density range that is sufficient to cause the additive composition to overcome the surface tension of the slag layer, and descend through the slag layer to at least reach so as to come into contact with, or to reside within, the molten metal layer. The target density of the composition may be such so as to cause the composition to come to reside entirely within the metal layer a good distance from the slag/metal interface

Once the target density is determined, the method further comprises selecting the components of the additive composition 104 and analyzing their densities 106. For example, an additive component such as anthracite and a ballast component such as granulated iron may be selected. The components are then blended in a proportion such that the density of the blended composition falls within the target density 108. The density of the blend may be sufficiently dense for the additive composition to be driven by gravity through the slag layer to the metal layer to come into contact with the metal layer. The blend is also formulated to maintain sufficient additive material to adjust the molten metal chemical composition as needed 110. In some cases, a binder may be added to the blend. In an example, the proportion of the additive component to the ballast component is such that the overall additive composition's apparent density is at least the same density of the metal layer. Furthermore, the additive component may be at least 10% of the total additive composition by weight.

The additive composition may be added to a molten metal making process to adjust the chemical composition of the molten metal. In an example, a main feed of ore or DRI may be added to an electric furnace to produce a molten metal. As the molten metal forms, a slag layer develops on the surface of the molten metal layer. The chemical composition of the molten metal is based on the main feed product charged into the furnace, for example, the carbon content in the DRI. Typically, this may be about 2% carbon. The chemical composition of the molten metal however may need adjustments to improve downstream processes, such as the steelmaking process, or such as the steelmaking process in an electric furnace. Improved steelmaking downstream in a basic oxygen furnace (BOF) for example may be achieved by increasing the carbon content of the hot liquid metal, for example to 3-4.5% or greater, by introducing an additive composition into the metal layer according to this disclosure.

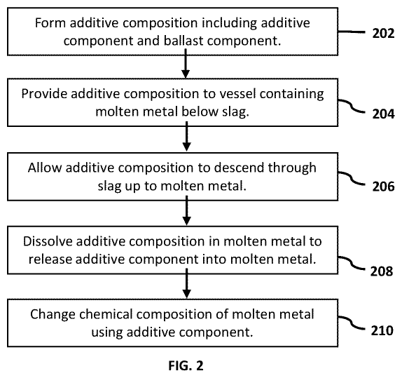

In an aspect of this disclosure as shown in FIG. 2, a method for adjusting a composition of molten liquid metal beneath a slag is provided. The process comprises forming an additive composition 202 comprising a liquid metal additive component and a ballast component, the conglomerate having a density that is greater than the density of the slag, and adding the additive composition to a vessel containing the liquid metal 204. For example the additive composition may be added through the top of a vessel comprising the molten liquid metal beneath the slag. In other examples, the additive composition may be charged into the top of the vessel, added by chute onto, by a charge port onto, or injected into, the slag layer. The additive composition may then be allowed to descend through the slag to the molten liquid metal under the force of gravity 206. In an example, the additive composition descends partially through the slag or until the additive composition resides at the molten metal and slag interface. In limited cases, the density of the additive composition may allow it to further descend into the molten metal layer. In such cases, the density of the additive composition is made to be similar to or greater than the density of the molten metal. The additive composition melts or dissolves in, or reacts with, the molten liquid 208 to release the liquid metal additive into the molten liquid metal, and optionally the additive composition melts or dissolves in, or reacts with the molten liquid metal and causes a change in the chemical composition of the molten liquid metal 210, and optionally the slag, through dissolution or reaction of the liquid metal additive component.

In an example process based on the present disclosure, carbon-bearing, iron-based heavy briquettes were used to achieve improved carburization (dissolution of carbon) into the liquid metal inside a DRI melting electric furnace. The process used heavy briquettes made by cold-bonding of anthracite fines (as the additive component; a source of carbon), DRI fines from direct reduction (as ballast component; containing a significant amount of metallized iron to provide density and is compatible with the process), and a commercial binder, such as sodium silicate (as a binder for cold bonding). The proportion of binder was no more than 10% while the other two components were adjusted to achieve an apparent density of 2-3 g/cm³, and at least 10% carbon. The cold-bonded heavy briquettes were then added to the exposed slag area of the electric furnace and the higher density of the additive composition was allowed to sink through the slag layer and come into act with the molten metal to interact directly with the molten metal, as opposed to floating above the slag layer when adding lower density additives directly. As the briquettes are melted or dissolved into the metal layer in the furnace, the carbon (whether as free carbon, cementite, or dissolved carbon in the metallized iron in the briquette) is dissolved into the liquid iron phase, whether through direct dissolution or through one or several possible intermediate reactions. The other components of the briquette were also melted or dissolved into their respective phases.

In a further example, an additive composition for improved carburization in the liquid metal may comprise 70% DRI fines (94% metallized DRI), 25% anthracite fines as the additive component to provide carbon, and 5% of a sodium silicate binder. Other additive compositions may be determined by a skilled person based on the target density and the desired effect on the chemical composition of the molten metal by tuning the relative percent by weight of each component such as to produce the desired density while maintaining at least 10% by weight of the additive.

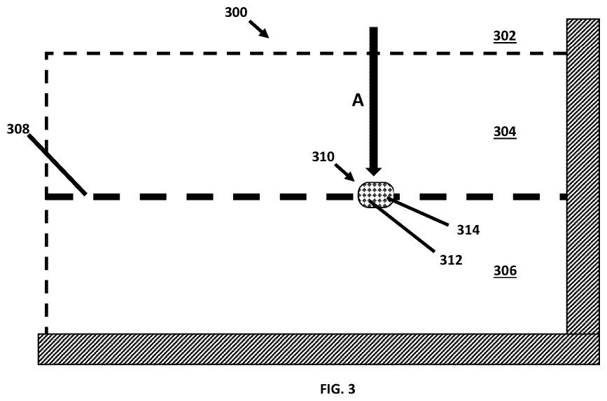

FIG. 3 shows a cross-section of a portion of a furnace 300 according to the present invention. The furnace 300 comprises a freeboard 302, a slag layer 304, and a metal layer 306. The slag 304 comprises a lower density than the molten metal 306 so that the slag 304 resides above the molten metal 306. The slag layer 304 and metal layer meet to define a slag-metal interface 308. The furnace also contains an additive composition 310 according to the present invention. The additive composition 310 comprises an additive component 312 and a ballast component 314. The ballast component 314 comprises a density greater than the slag 304. The ballast component 314 may have a density less than, equal to, or greater than the molten metal 306. The additive component 312 may have a density less than the slag. The density of the ballast component 314 and the amount of the ballast component 314 bound with the additive component 312 results in the additive composition 310 having an overall density greater than the slag 304. In this way the ballast component 314 contributes to the additive composition 310 having an overall density greater than the slag 304. The ballast component 314 was provided into the furnace at the freeboard 302 and descended under the force of gravity through the slag layer 304 in direction A so as to come to rest at the slag-metal interface 308. Resting at the slag-metal layer, the additive composition 310 is in at least partial contact with the molten metal 306. This causes the additive composition 310 to melt and/or dissolve at least a portion of the additive component within the molten metal 306 to chemically adjust the molten metal 306.

We claim:

1. An additive composition for carburizing molten metal iron, the composition comprising an additive component comprising carbon bound with a ballast component comprising iron, wherein a density of the ballast component is greater than a density of slag to enable the additive composition to contact the molten metal iron produced by an electric smelting furnace from direct reduced iron, and to melt or dissolve at least a portion of the additive component within the molten metal iron for carburizing the molten metal iron.

2. The additive composition of claim 1, wherein the additive composition has a density greater than the density of the slag.

3. The additive composition of claim 2, wherein the density of the additive composition causes the additive composition to sink through the slag to contact the molten metal iron beneath the slag.

4. The additive composition of claim 1, wherein the additive component is physically bound with the ballast component.

5. The additive composition of claim 1, wherein the additive component is chemically bound with the ballast component.

6. The additive composition of any one of claims 1-5, further comprising a binder for helping bind the additive component to the ballast component.

7. The additive composition of claim 6, wherein the binder comprises one or more of cement, molasses, bentonite, lime, sodium silicate or any other suitable binder.

8. The additive composition of any one of claims 6-7, wherein the binder makes up a maximum of 15% of the composition by weight.

9. The additive composition of any one of claims 1-8, wherein the additive component is at least 10% of the total composition by weight.

10. The additive composition of any one of claims 1-8, wherein the density of the ballast causes the composition to have a density sufficient for the composition to reside at the interface between the molten metal iron and the slag layer.

11. The additive composition of any one of claims 1-10, wherein the composition is in the form of a conglomerate, briquettes, pellets, micro-pellets, sintered particles, or bonded particles.

12. The additive composition of any one of claims 1-11, wherein the additive component has a density lower than the density of the slag, or the additive component is in a form that is inhibited from sinking into the slag layer.

13. The additive composition of any one of the preceding claims, wherein the additive component comprises any one or more of: coal, coke, anthracite, charcoal, biocarbon, biomass, cementite and various metal carbides, elemental carbon, carbon black, graphite or another carbon-containing component.

14. The additive composition of any one of the preceding claims, wherein the ballast component comprises direct reduced iron (DRI).

15. The additive composition of any one of the preceding claims, wherein the ballast component comprises any one or more of: direct reduced iron (DRI) fines, finely shredded metal scrap, and powdered or granulated iron, iron carbide/ferroalloys.

16. The additive composition of any one of the preceding claims for use in a furnace with a quiescent slag layer.

17. The additive composition of any one of the preceding claims, wherein the ballast component is comprised of material that is compatible with the molten metal iron.

18. The additive composition of any one of the preceding claims, wherein the ballast component comprises the same material as found in the molten metal iron.

19. The additive composition of any one of the preceding claims, wherein the additive component comprises materials for adjusting the composition of the molten metal iron, through direct dissolution or through one or more intermediate reactions.

20. The additive composition of any one of the preceding claims, wherein the density of the ballast is equal to or greater than the density of the molten metal iron.

21. The additive composition of any one of the preceding claims, wherein the density of the composition is equal to or greater than the density of the molten metal iron.

22. A method for carburizing molten metal iron, the method comprising
forming an additive composition comprising an additive component for the molten metal iron bound with a ballast component, the additive component comprising carbon, the ballast component comprising iron with a density greater than a density of slag;
providing the additive composition to come into contact with the molten metal iron produced by an electric smelting furnace from direct reduced iron;
melting or dissolving the additive composition to release at least a portion of the additive component to the molten metal iron; and
carburizing the molten metal iron with the additive component.

23. The method of claim 22, wherein the additive composition has a density that is greater than the density of slag.

24. The method of claim 23, wherein the additive composition is provided to the top of the slag and the additive composition is allowed to descend through the slag to come into contact with the molten metal iron under the force of gravity.

25. The method of claim 22, wherein carburizing the molten metal iron comprises direct dissolution of the additive component into the molten metal iron, or through one or multiple intermediate reactions.

26. The method of any one of claims 22-25, wherein forming the additive composition comprises forming any one or more of conglomerates, pellets, briquettes, micro-pellets, DRI, sintered particles, and bonded particles.

27. The method of any one of claims 22-26, wherein providing the additive composition comprises adding the additive composition to the vessel as a mixture with any other feed material.

28. The method of any one of claims 22-27, further comprising monitoring a chemical composition of the molten metal iron and providing further additive composition to the vessel periodically to adjust the chemical composition of the molten metal iron to achieve a select chemical composition for the molten metal iron.

29. The method of any one of claims 22-28, wherein forming the additive composition comprises adhering particles of the additive component with particles of the ballast component to form one or more units of the additive composition, each of the units having a density greater than the density of the slag.

30. The method of any one of claims 22-29, wherein forming the additive composition comprises
a) defining a target density range based on a process for producing molten metal, the target density range being greater than the density of the slag;
b) selecting the additive component and the ballast component;
c) determining the density of the additive component and the density of the ballast component; and
d) combining the additive component with the ballast component in necessary proportions to form the additive composition that falls within the target density range.

31. The method of any one of claims 22-30, wherein the additive component is at least 10% by weight of the additive composition.

32. The method of claim 30, wherein the target density range is equal to or greater than the density of the molten metal produced by the process for producing the molten metal.

33. The method of any one of claims 22-32, further comprising selecting a binder, determining a density of the binder, and combining the binder with the additive component and the ballast component in necessary proportions to help form the additive component with the ballast component to produce the additive composition that falls within the target density range.

34. The method of any one of claims 22-33, wherein selecting the additive component comprises selecting one or more of coal, coke, anthracite, charcoal, carbon, graphite, biocarbon, biomass, cementite, aluminum, or a metal carbide.

35. The method of any one of claims 22-34, wherein the ballast component is selected to have a density equal to or greater than the density of the molten metal iron.

36. The method of any one of claims 22-35, further comprising forming the additive composition with a ballast comprising a density to cause the additive composition to have a sufficient density to come to rest at the interface between the slag and the molten metal iron.

37. The method of any one of claims 22-36, wherein the ballast component is selected to cause the additive composition to reside entirely within the molten metal iron.

38. The method of any one of claims 22-37, wherein forming the additive composition comprises forming the ballast component of direct reduced iron (DRI).
